(19) United States
(12) Patent Application Publication
(10) Pub. No.: US 2017/0228829 A1
(43) Pub. Date: Aug. 10, 2017

(54) System and Method for Retrieving a Lost Item

(71) Applicant: Bassem Alhalabi, Boca Raton, FL (US)

(72) Inventor: Bassem Alhalabi, Boca Raton, FL (US)

(21) Appl. No.: 15/017,869

(22) Filed: Feb. 8, 2016

(51) Int. Cl. G06Q 50/00; G06Q 10/08; G06Q 20/10

(52) U.S. Cl. CPC G06Q 50/01; G06Q 20/102; G06Q 10/083

(57) ABSTRACT

A system and method for retrieving a lost item is configured to enable efficient retrieval of at least one item that has been lost by a first user and found by a second user. The system and method enables a first user and a second user to register in a data storage site and communicate through a forum for indicating loss of the item and verification of ownership of the item. The system and method also enables the item to be registered in the data storage site prior to being lost, such that identification and return of the lost item is centralized. The system and method further enables the first user to offer incentives for return of the lost item. The system and method is also monetized by charging a fee to the users for access to the data storage site and the forum.

### FIELD OF THE INVENTION

The present invention relates generally to a system and method for retrieving a lost item. More so, a system and method facilitates the retrieval of an item that is lost by a first user and found for returning to the first user by a second user; whereby the system and method enables the users to register contact information in a data storage site in which each user has access, associate the lost item with the appropriate user by labeling the item with a unique identifying label and registering the item in the data storage site, indicate loss of the item on a forum, verify ownership of the item by crosschecking the unique identifying label with the registered items in the data storage site, facilitate delivery of the lost item to the first user through a shipping agency, incentivize the return of the lost item by enabling the first user to post a reward for return of the lost item, and monetize the system by charging the users a fee for access to the data storage site and forum.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that a lost and found is an office in a public building or area where people can go to retrieve lost articles that may have been found by others. The lost and found is frequently found at museums, amusement parks and schools, a lost and found will typically be a clearly marked box or room in a location near the main entrance.

It is known that a database is an organized collection of data. The data is typically organized to model aspects of reality in a way that supports processes requiring information, such as modelling items in a warehouse to differentiate between the different types, sizes, and availability of the items. Additionally, a social site is a social structure made up of a set of social actors. Often, the social network is purposed for a specific function. The social site is often accessible on a website of the Internet. Social media are computer-mediated tools that allow people to create, share, or exchange information, career interests, ideas, and pictures/videos in virtual communities and networks. In many instances, discussions about lost items may be possible on a dedicated social media site.

Other proposals have involved systems for lost and found. The problem with these systems is that they do not provide efficient communication between the finder and the loser of the item. The prior art also does not do enough to provide incentives for return of the lost item; nor does the system generate revenue. Even though the above cited lost and found systems meet some of the needs of the market, a system and method for retrieving a lost item that is configured to enable efficient retrieval of at least one item that has been lost by a first user and found by a second user, while providing incentives and generating revenue, is still desired.

### SUMMARY OF THE INVENTION

The present invention is directed to a system and method for retrieving a lost item. The system and method is configured to enable efficient retrieval of at least one item that has been lost by a first user and found by a second user. The system and method enables a first user and a second user to register in a data storage site and communicate through a forum for indicating loss of the item and verification of ownership of the item. The system and method also enables the item to be registered in the data storage site prior to being lost, such that identification and return of the lost item is centralized. The system and method further enables the first user to offer incentives for return of the lost item. The system and method is also monetized by charging a fee to the users for access to the data storage site and the forum.

In one embodiment, the system and method enables a first user to retrieve a lost item that is found by a second user. The item may include, a valuable item, a sentimental item, or a living creature that the first user has misplaced, left, or temporarily abandoned. The system and method utilizes a data storage site, such as a server that is accessible through a website or a network, to enable identification of the lost item and facilitate communication between the users that have lost and found the item.

In some embodiments, a first user and a second user may register in the data storage site. The registration may include information such as: shipping address of the first and second users, the amount of a monetary unit offered by the user to incentivize return of a lost item, and the preferred shipping means for returning the lost item. Though in some embodiments, the identification of the users remains substantially anonymous. To provide an incentive for returning lost items, the registration may also require the users to open an account with a monetary unit. The account provides a reward for the first user to pay a second user that finds and returns the lost item to the first user.

In some embodiments, the users register the item and the unique identifying label in the data storage site. This step occurs prior to potentially losing the items. The users also affix a unique identifying label on the items. The unique identifying label for each item is registered in the data storage site; thereby associating the item with the appropriate user.

In some embodiments, a first user may indicate loss of an item by posting a message on a forum. The forum may include a website, a message board, and a public forum that is accessible by the second user. Each user has at least partial access to the data storage site and the forum, for viewing lost items, the unique identifying labels, lost item messages, lost item alerts, and contact information of other users.

Thus, upon finding the lost item and viewing the message, the second user may verify ownership of the lost item by comparing the first user's stated description of the lost item and the unique identifying label of the lost item. Upon determining the appropriate owner of the lost item, the second user may communicate with the first user to indicate that the lost item has been found. The first user may also indicate to the second user that a reward is available for return of the lost item. Though in some embodiments, the reward information may be posted on the forum

A shipping agency may serve to deliver the lost item to the first user. In one embodiment of incentivizing retrieval of the item, the second user provides the lost item to the shipping agency after receiving the monetary unit from the first user. In another embodiment, the monetary unit is held by the system, and released to the second user after the second user provides the lost item to the shipping agency for shipping to the first user. In this embodiment, the system serves as a proxy, transferring the reward from the registered account of the first user to the account of the second user. The system may collect a fee for enabling the communication between users, and serving as a proxy for the reward upon return of the lost item.

In one aspect, a method for retrieving a lost item, comprises:
registering a first user and a second user in a data storage site;
associating at least one item with the first user and the second user with a unique identifying label;
registering the at least one item and the unique identifying label in the data storage site;
depositing a monetary unit in a first user account and a second user account;
if the at least one item is lost by the first user, indicating on a forum the loss of the at least one item;
indicating on the forum, by the first user, the availability of at least a portion of the monetary unit upon retrieval of the at least one item;
if the at least one item is found by the second user, verifying ownership of the at least one item to the first user through the unique identifying label;
providing, by the second user, the at least one item to a shipping agency, the shipping agency operable to deliver the at least one item to the first user;
transferring the at least a portion of the monetary unit from the first user account to the second user account; and
charging a fee for enabling registration of the first user and the second user, and for transferring at least a portion of the monetary unit.

In another aspect, the first user and the second user comprise a network of users.

In another aspect, the step of charging a fee, further includes paying a periodic fee by the first user and the second user for registering on the data storage site.

In another aspect, the periodic fee comprises one dollar each month.

In another aspect, the data storage site includes at least one member selected from the group consisting of: a database, a server, a network, a processor, and a call center.

In another aspect, the data storage site is configured to operatively connect to the forum.

In another aspect, the at least one item includes at least one member selected from the group consisting of: a valuable item, a sentimental item, a living creature, a camera, a key, a laptop, a wallet, a suitcase, and a book.

In another aspect, the forum includes at least one member selected from the group consisting of: a website, a message board, a community meeting, and a newspaper.

In yet another aspect, the unique identifying label comprises a bar code label.

In yet another aspect, the bar code label comprises a sticker or a metallic label.

In yet another aspect, the monetary unit comprises a reward.

In yet another aspect, the shipping agency comprises a parcel delivery agency.

In yet another aspect, the step of indicating on a forum, by the first user, a loss of the at least one item, further includes logging into the data storage site.

In yet another aspect, the step of verifying, by the second user, ownership of the lost at least one item to the first user through the unique identifying label, further includes scanning the unique identifying label.

In yet another aspect, the method further include a step of maintaining anonymity between the first user and the second user.

In yet another aspect, the method further include a step of scanning, by the shipping agency, the at least one item to identify a shipping address for the first user.

In yet another aspect, the step of scanning, by the shipping agency, the at least one item to identify a shipping address for the first user, further includes notifying the first user prior to shipping the at least one item.

In yet another aspect, the step of transferring the at least a portion of the monetary unit from the first user account to the second user account, further includes receiving, by the first user the at least one item before the transfer of the at least a portion of the monetary unit.

It is one objective of the present invention to provide a system that enables at least one item that has been lost by a first user to be retrieved efficiently through the help of a second user, and a network of users.

It is another objective to encourage the second user to take the time to verify a found item from the data storage site and return the item to the first user.

It is another objective to provide a monetary incentive for the second user to find and return the lost item.

It is another objective to provide a centrally accessible data storage site for a network of users to register contact information and items.

Yet another objective is to provide a forum for a network of users to share information about lost items.

Yet another objective is to enable association of the item with the user through a scannable unique identifying label.

Yet another objective is to utilize a shipping agency to ship the found item to the first user.

Yet another objective is to provide an easy to use system and method for retrieving lost items.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary system for retrieving a lost item, in accordance with an embodiment of the present invention; and

FIG. 2 illustrates a flowchart of an exemplary method for retrieving a lost item, in accordance with an embodiment of the present invention.

Like reference numerals refer to like parts throughout the various views of the drawings.

### DETAILED DESCRIPTION OF THE INVENTION

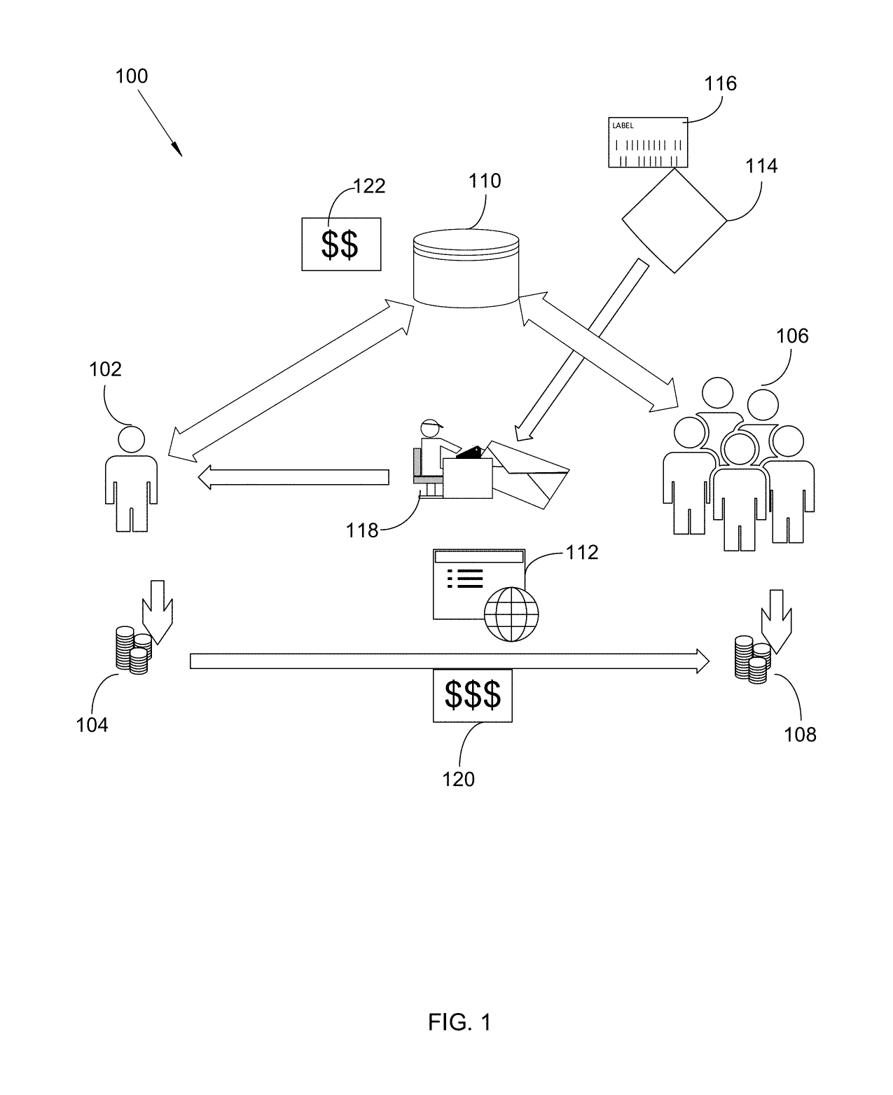

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

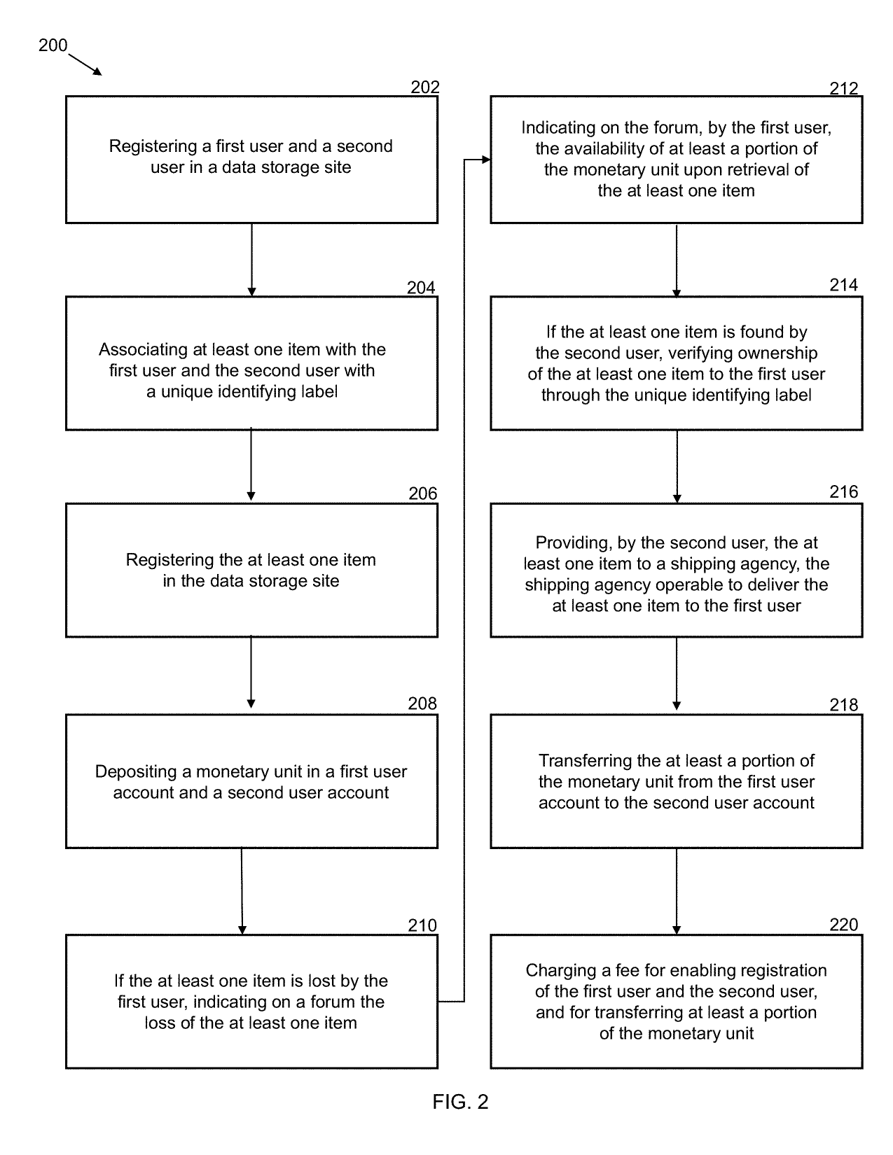

FIGS. 1-2 illustrate a system 100 and method 200 for retrieving a lost item. In one embodiment, referenced in FIG. 1, the system 100 for retrieving a lost item 114 is configured to enable efficient retrieval of at least one item 114 that has been lost by a first user 102 and found by a second user 106. The system 100 is especially effective for enabling the first user 102 and the second user 106 to register in a data storage site 110 and communicate through a forum 112 for indicating loss of the item 114 and verifying ownership of the item 114. The first user 102 and the second user 106 may be part of a network of users. For example, the users 102, 106 may be part of a global organization that facilitates the retrieval of lost items.

The system 100 also enables the item 114 to be registered in the data storage site 110 prior to being lost, such that identification and return of the lost item 114 is centralized. This registration is operable to centralize the system 100 for more efficient communication between users 102, 106 and identification of lost item 114. The system 100 further enables the first user 102 to offer incentives for return of the lost item 114. The incentives may include a monetary unit 120. Though in other embodiments, services, donations, and nonmonetary units may be used as an incentive. The system 100 is also monetized to generate revenue. In some embodiments, the monetization may be accomplished by charging a fee 122 to the users 102, 106 for access to the data storage site 110 and the forum 112.

In one embodiment, the system 100 enables a first user 102 to retrieve a lost item 114 that is found by a second user 106. The first user 102 and the second user 106 may be interchangeable, such that the second user 106 retrieves a lost item 114 that is found by the first user 102. The second user 106 may also represent a plurality of users who find the item 114. The at least one item 114 may include, without limitation, a valuable item, a sentimental item, a living creature, a camera, a key, a laptop, a wallet, a suitcase, and a book. The item 114 may have been lost when the first user 102 misplaced the item, inadvertently left the item 114, been robbed of the item 114, or temporarily abandoned the item 114.

The system 100 utilizes a data storage site 110, such as a server, that is accessible through a forum 112, such as a website or a network. The data storage site 110 and the forum 112 enable identification of the lost item 114 and facilitate communication between the users 102, 106 that have lost and found the item 114. The data storage site 110 may include, without limitation, a database, a server, a network, a processor, and a call center.

As referenced in FIG. 1, the first user 102 and the second user 106 may register in the data storage site 110. In one exemplary embodiment, all the users 102, 106 (finders and losers) sign up and register their information on a master cloud-based database. The registration may include information such as: shipping address of the first and second user 102, 106, the amount of a monetary unit 120 offered by the first user 102 to incentivize return of a lost item 114, and the preferred shipping means for returning the lost item 114. In some embodiments, the identification of the first and second users 102,106 remains substantially anonymous, despite sharing addresses and information about the item 114.

To provide an incentive for returning lost item 114, the registration may also require the users 102, 106 to open a first user account 104 and a second user account 108 that contain a monetary unit 120. The accounts 104, 108 enable the first user 102 to pay the second user 106 a reward for finding and returning the lost item 114 to the first user 102. The aspect of the reward is flexible. For example, the first user 102 may change the reward amount in real time. The first user 102 may also offer a reward having no monetary value. In one embodiment, the reward is dictated by the first user at the time that the item 114 was determined to be lost.

Those skilled in the art will recognize that the monetary unit 120 of the reward must be sufficient to motivate the second user to find and send the item 114 back to the first user 102. In one exemplary use, the first user 102 is traveling and loses a camera. The camera value is a $100, but there are sentimental photos which are valuable to the first user. Thus, the first user may offer a reward of $200 for any second user 106 to find and return the camera. In addition to the reward, the accounts 104, 108 are also used to cover shipping costs and to pay the fee 122.

In some embodiments, the users 102, 106 register the item 114 in the data storage site 110 prior to potentially losing the item 114. The users 102, 106 may also affix a unique identifying label 116 on the items 114. A unique identifying label 116 for each item 114 is registered in the data storage site 110; thereby associating the item 114 with the appropriate user 102, 106. In some embodiments, the unique identifying label 116 comprises a bar code label, such as a sticker or a metallic label. A bar code system that is scanned with an optical reading device may be used to input the item 114 into the data storage site 110.

In some embodiments, a first user 102 may indicate loss of an item 114 by posting a message or an alert on a forum 112. The last known location of the item 114 may be described, as well as the reward for return of the item 114. The forum 112 may include, without limitation, a website, a message board, and a public forum that is accessible by both the first and second users 102, 106. The data storage site 110 is configured to operatively connect to the forum 112. Each user 102, 106 has at least partial access to the data storage site 110 and the forum 112, for viewing lost items 114, viewing messages and alerts, associating the unique identifying label 116 with the appropriate lost item 114 messages, and searching for contact information of other users 102.

Thus, upon finding the lost item 114 and viewing the message, the second user 106 may verify ownership of the lost item 114 by comparing the first user's 102 stated description of the lost item 114 and the unique identifying label 116 of the lost item 114. Upon determining the appropriate owner of the lost item 114, the second user 106 may communicate with the first user 102 to indicate that the lost item 114 has been found. The first user 102 may also indicate to the second user 106 that a reward is available for return of the lost item 114. Though in some embodiments, the reward information may be posted on the forum 112.

Looking again at FIG. 1, a shipping agency 118 may serve to deliver the lost item 114 to the first user 102. The shipping agency 118 may include a parcel delivery agency 118. The second user 106 delivers the item 114 to the shipping agency 118. Though in other embodiments, the shipping agency 118 picks up the item 114 from the second user 106. The shipping agency 118 may be compensated for the delivery from the first user account 104 of the first user 102. In some embodiments, the shipping agency 118 may notify the first user 102 prior to shipping the item 114.

In one embodiment of incentivizing retrieval of the item 114, the second user 106 provides the lost item 114 to the shipping agency 118 after receiving the monetary unit 120 from the first user 102. In another embodiment, the monetary unit 120 is held by the system 100 in the first user account 104, and released to the second user account 108 after the second user 106 provides the lost item 114 to the shipping agency 118 for shipping to the first user 102. In this embodiment, the system 100 serves as a proxy, transferring the reward from the registered first user account 104 of the first user 102 to the second user account 108.

In some embodiments, the system 100 may generate revenue by collecting a fee 122 from the first user 102 and the second user 106. The fee 122 is assessed for enabling the communication between users 102, 106 on the forum 112, storing the information on the data storage site 110, and serving as a proxy for the reward upon return of the item 114. The fee 122 may include a periodic fee 122 that is paid by the first user 102 and the second user 106. In one embodiment, the periodic fee 122 is one dollar per month. Though in other embodiments, no fee 122 is assessed.

In one exemplary use of the system 100, the first user 102 and the second user 106 (finders and losers) register and open an account in the data storage site 110. The users 102, 106 sign up and register their information on a master cloud-based database. Once the users 102, 106 register and create an account, the users 102, 106 gradually register the at least one item 114 on the cloud one at a time by simply clicking on a “New Item” button. Then the system 100 creates the unique identifying label 116, such as a unique barcode which the user can print and attached to the item 114.

The system is effective in this manner in that there are no expensive communication devices such RFID, etc. which are bulky and may need batteries. Thus, when the user 106 finds a lost item, user 106 can simply scan the bar code on the item 114 using a software application downloaded onto a communication device. The software application automatically indicates to the user 106 that the item is indeed lost and that user 102 is looking for it, and has a reward when returned. Next, the identities of both users 102, 106 are secured in a centralized web service center, and never communicated to each other.

The software application on the losing user's 102 communication device also reports to the database that the item had been found by the finding user 106. The finding user 106 may simply drop the found item 114 at the nearest shipping agency 118 for return to the user 102. The returning process through a local shipping agency is made seamless via a shipping software application that is downloadable into the computer, and once the shipping agency 118 scans the barcode, to print a return shipping label. The reward of the monetary unit 120 that is provided by the losing user 102 is also made seamless through a special accounting system for each participant (owner or finder) in the system 100.

FIG. 2 illustrates a flowchart diagram of an exemplary method 200 for retrieving a lost item. The method 200 may include an initial Step 202 of registering a first user and a second user in a data storage site. The first user 102 and the second user 106 may register in the data storage site 110. The registration may include information such as: shipping address of the first and second user 102, 106, the amount of a monetary unit 120 offered by the first user 102 to incentivize return of a lost item 114, and the preferred shipping means for returning the lost item 114.

The method 200 may further comprise a Step 204 of associating at least one item with the first user and the second user with a unique identifying label. In some embodiments, the users 102, 106 register the item 114 in the data storage site 110 prior to potentially losing the item 114. The users 102, 106 may also affix a unique identifying label 116 on the items 114. A unique identifying label 116 for each item 114 is registered in the data storage site 110; thereby associating the item 114 with the appropriate user 102, 106.

In some embodiments, a Step 206 includes registering the at least one item and the unique identifying label in the data storage site. Through the registered unique identifying label 116 the owner of the item 114 may be learned. A Step 208 comprises depositing a monetary unit in a first user account and a second user account. To provide an incentive for returning lost item 114, the registration may also require the users 102, 106 to open a first user account 104 and a second user account 108 that contain a monetary unit 120. The accounts 104, 108 enable the first user 102 to pay the second user 106 a reward for finding and returning the lost item 114 to the first user 102. The accounts 104, 108 are also used to cover shipping costs and to pay the fee 122.

A Step 210 is performed if the at least one item is lost by the first user, indicating on a forum the loss of the at least one item. The indication may include posting a message or an alert. The last known location of the item 114 may also be described, as well as the reward for return of the item 114. In some embodiments, a Step 212 may include indicating on the forum, by the first user, the availability of at least a portion of the monetary unit upon retrieval of the at least one item.

A Step 214 is performed if the at least one item is found by the second user, verifying ownership of the at least one item to the first user through the unique identifying label. Upon finding the lost item 114 and viewing the message, the second user 106 may verify ownership of the lost item 114 by comparing the first user's 102 stated description of the lost item 114 and the unique identifying label 116 of the lost item 114. Upon determining the appropriate owner of the lost item 114, the second user 106 may communicate with the first user 102 to indicate that the lost item 114 has been found.

A Step 216 includes providing, by the second user, the at least one item to a shipping agency, the shipping agency operable to deliver the at least one item to the first user. The shipping agency 118 may serve to deliver the lost item 114 to the first user 102. The shipping agency 118 may include a parcel delivery agency 118. The second user 106 delivers the item 114 to the shipping agency 118. Though in other embodiments, the shipping agency 118 picks up the item 114 from the second user 106.

Another Step 218 includes transferring the at least a portion of the monetary unit from the first user account to the second user account. This transfer represents the reward offered by the first user 102 for finding and returning the item 114. A final Step 220 comprises charging a fee for enabling registration of the first user and the second user, and for transferring at least a portion of the monetary unit. In some embodiments, the system 100 may generate revenue by collecting a fee 122 from the first user 102 and the second user 106. The fee 122 is assessed for enabling the communication between users 102, 106 on the forum 112, storing the information on the data storage site 110, and serving as a proxy for the reward upon return of the item 114.

These and other advantages of the invention will be further understood and appreciated by those skilled in the art by reference to the following written specification, claims and appended drawings.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A method for retrieving a lost item, the method comprising:
registering a first user and a second user in a data storage site;
associating at least one item with the first user and the second user with a unique identifying label;
registering the at least one item and the unique identifying label in the data storage site;
depositing a monetary unit in a first user account and a second user account;
if the at least one item is lost by the first user, indicating on a forum the loss of the at least one item;
indicating on the forum, by the first user, the availability of at least a portion of the monetary unit upon retrieval of the at least one item;
if the at least one item is found by the second user, verifying ownership of the at least one item to the first user through the unique identifying label;
providing, by the second user, the at least one item to a shipping agency, the shipping agency operable to deliver the at least one item to the first user;
transferring the at least a portion of the monetary unit from the first user account to the second user account; and
charging a fee for enabling registration of the first user and the second user, and for transferring at least a portion of the monetary unit.

2. The method of claim 1, wherein the first user and the second user comprise a network of users.

3. The method of claim 1, further including a step of maintaining anonymity between the first user and the second user.

4. The method of claim 1, wherein the step of charging a fee, further includes paying a periodic fee by the first user and the second user for registering on the data storage site.

5. The method of claim 1, wherein the periodic fee comprises one dollar each month.

6. The method of claim 1, wherein the data storage site includes at least one member selected from the group consisting of: a database, a server, a network, a processor, and a call center.

7. The method of claim 1, wherein the data storage site is configured to operatively connect to the forum.

8. The method of claim 1, wherein the at least one item includes at least one member selected from the group consisting of: a valuable item, a sentimental item, a living creature, a camera, a key, a laptop, a wallet, a suitcase, and a book.

9. The method of claim 1, wherein the forum includes at least one member selected from the group consisting of: a website, a message board, a community meeting, and a newspaper.

10. The method of claim 1, wherein the unique identifying label comprises a bar code label.

11. The method of claim 10, wherein the bar code label comprises a sticker or a metallic label.

12. The method of claim 1, wherein the monetary unit comprises a reward.

13. The method of claim 1, wherein the shipping agency comprises a parcel delivery agency.

14. The method of claim 1, wherein the step of indicating on a forum, by the first user, a loss of the at least one item, further includes logging into the data storage site.

15. The method of claim 1, wherein the step of verifying, by the second user, ownership of the lost at least one item to the first user through the unique identifying label, further includes scanning the unique identifying label.

16. The method of claim 1, further including a step of scanning, by the shipping agency, the at least one item to identify a shipping address for the first user.

17. The method of claim 16, wherein the step of scanning, by the shipping agency, the at least one item to identify a shipping address for the first user, further includes notifying the first user prior to shipping the at least one item.

18. The method of claim 1, wherein the step of transferring the at least a portion of the monetary unit from the first user account to the second user account, further includes receiving, by the first user the at least one item before the transfer of the at least a portion of the monetary unit.

19. A system for retrieving a lost item, the system comprising:
a data storage site, the data storage site configured to store information about a first user and a second user, the data storage site further configured to store information about at least one item;
a unique identifying label, the unique identifying label comprising associating indicia for the at least one item, the unique identifying label configured to attach to the at least one item, the unique identifying label further configured to associate the least one item with the first user and the second user;
a forum, the forum configured to enable the first user to indicate a loss of the at least one item, the forum further configured to enable the second user to verify the loss of the at least one item by the first user through the unique identifying label upon finding the at least one item;
a shipping agency, the shipping agency configured to transport the at least one item from the second user to the first user; and
a monetary unit, the monetary unit comprising a reward provided by the first user, the monetary unit configured to be transferred from a first user account to a second user account upon transport of the at least one item from the second user to the first user.

20. A method for retrieving a lost item, the method comprising:
registering a first user and a second user in a data storage site;
associating at least one item with the first user and the second user with a unique identifying label;
registering the at least one item and the unique identifying label in the data storage site;
depositing a monetary unit in a first user account and a second user account;
if the at least one item is lost by the first user, indicating on a forum the loss of the at least one item;
indicating on the forum, by the first user, the availability of at least a portion of the monetary unit upon retrieval of the at least one item;
if the at least one item is found by the second user, verifying ownership of the at least one item to the first user through the unique identifying label;
providing, by the second user, the at least one item to a shipping agency, the shipping agency operable to deliver the found at least one item to the first user;
scanning, by the shipping agency, the at least one item to identify a shipping address for the first user;
notifying the first user prior to shipping the at least one item;
transferring the at least a portion of the monetary unit from the first user account to the second user account; and
charging a fee for enabling registration of the first user and the second user, and for transferring at least a portion of the monetary unit.
